(19) United States
(12) Patent Application Publication
(10) Pub. No.: US 2024/0428490 A1
(43) Pub. Date: Dec. 26, 2024

(54) INTELLIGENT AND CULTURALLY AWARE VIRTUAL AVATARS

(71) Applicant: International Business Machines Corporation, Armonk, NY (US)

(72) Inventors: Jill S. Dhillon, Jupiter, FL (US); Stan Kevin Daley, Espanola, NM (US); Madhusmita Patil, Hyderabad (IN); Lucia Larise Stavarache, Columbus, OH (US); Jennifer M. Hatfield, Portland, OR (US); Marina-Adriana Mercioni, Timisoara (RO)

(21) Appl. No.: 18/339,306

(22) Filed: Jun. 22, 2023

(51) Int. Cl. G06T 13/40

(52) U.S. Cl. CPC G06T 13/40

(57) ABSTRACT

Techniques are described with respect to a system, method, and computer program product for optimizing a virtual avatar. An associated method includes analyzing a virtual environment in order to ascertain one or more skill gaps associated with the virtual avatar; receiving a plurality of avatar data; and redefining the virtual avatar by filling the one or more skill gaps based on the analysis and the plurality of avatar data.

### FIELD

This disclosure relates generally to virtual avatars, and more particularly to computing systems, computer-implemented methods, and computer program products configured to provide intelligent and culturally aware virtual avatars within virtual environments.

Avatars have become inherent components of virtual environments, such as metaverses, that allow cognitive capabilities of users to be manifested resulting in the avatars being able to move, converse, interpret, etc. within virtual environments. For example, avatars may be configured to support cognitive functions that allow users to facilitate collaborative sessions, such as multi-party discussions (e.g., virtual conferences, etc.) in real-time with the avatars serving as a proxy of users within virtual environments. In some instances, the avatars are designed to resemble characteristics of users (e.g., appearance, mannerisms, style, etc.) and/or customizable features that are depicted within the virtual environments. Additionally, avatars may serve as virtual assistants and/or chatbots of a virtual environment allowing users to interact with virtual objects of the environment in real-time for various purposes (e.g., Q&A, customer service, FAQ, etc.).

In addition, machine learning, natural language processing, and other applicable artificial intelligence-based techniques may be utilized to optimize rendering of the avatars, which may enhance the design, features, and cognitive functions of the avatars. However, as the popularity of metaverses continue to increase, the context and cultural elements associated with the virtual environments the avatars are being used within becomes more useful for avatar functionality. For example, avatars utilized within metaverses associated with businesses across manufacturing, healthcare, energy, retail and training and development applications, etc. have the ability to not only directly improve user experience, but also impact the presentation of content to users in respect to the applicable metaverse environment by providing knowledgeable avatars trained on cultural elements specific to the metaverse.

### SUMMARY

Additional aspects and/or advantages will be set forth in part in the description which follows and, in part, will be apparent from the description, or may be learned by practice of the invention.

Aspects of an embodiment of the present invention disclose a method, system, and computer program product for optimizing a virtual avatar. In some embodiments, the computer-implemented method for optimizing a virtual avatar comprises analyzing a virtual environment in order to ascertain one or more skill gaps associated with the virtual avatar; receiving a plurality of avatar data; and redefining the virtual avatar by filling the one or more skill gaps based on the analysis and the plurality of avatar data.

In some aspects of an embodiment of the present invention, a computing device extracts a plurality of redefined avatar data and transmits the plurality of redefined avatar data based on one or more of a geographic location and a skill level associated with the virtual environment based on the redefining of the virtual avatar.

In some aspects of an embodiment of the present invention, the plurality of avatar data is derived from a corpus comprising one or more of a skill level, a cultural metric, a metaverse context, and a plurality of avatar templates.

In some aspects of an embodiment of the present invention, the receiving of the plurality of avatar data includes utilizing one or more machine learning models designed to process one or more of a plurality contextual data, a plurality of cultural-based data, a plurality of sensor data, and a plurality of linguistic inputs associated with the virtual environment.

In some aspects of an embodiment of the present invention, analyzing the virtual environment includes classifying a type of the virtual environment based on a plurality of linguistic inputs associated with a plurality of users operating within the virtual environment.

In some aspects of an embodiment of the present invention, analyzing the virtual environment further includes determining a plurality of key performance indicators associated with the virtual avatar based on one or more of a user associated with the virtual avatar and the plurality of avatar templates, and generating a confidence score associated with the virtual avatar based on weighing the plurality of key performance indicators.

In some aspects of an embodiment of the present invention, the corpus is generated based on a plurality of crowdsourced data derived from a plurality of metaverses configured to be iteratively analyzed over a period of time.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a virtual environment analysis and avatar optimization system environment, according to an exemplary embodiment;

FIG. 3 illustrates a block diagram of various modules associated with the virtual environment analysis module and avatar optimization module of FIG. 2, according to an exemplary embodiment;

FIG. 4 illustrates an avatar template generated based on an analysis of the virtual environment analysis module, according to an exemplary embodiment;

FIG. 5 illustrates an optimized avatar integrated into a cultural virtual environment, according to an exemplary embodiment; and

FIG. 6 illustrates an exemplary flowchart depicting a method for optimizing a virtual avatar, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for optimizing a virtual avatar. Virtual avatars are configured to be dynamically created and depicted within virtual environments, such as metaverses, in which avatars may not only serve as representations of users operating within virtual environments, but also as virtual assistants, chatbots, subject matter experts, etc. configured to interact with users in order to optimize the virtual reality and augmented reality experience. For example, a user's avatar may interact with a virtual assistant avatar within a virtual environment, in which the virtual assistant avatar guides the user with utilizing tools, features, etc. associated with the given virtual environment. However, as utilization of virtual environments such as metaverses continue to increase in popularity across various industries, the ability for avatars to be optimized based on the respective virtual environments that they are immersed in becomes integral to the user experience. Therefore, the present embodiments have the capacity to provide a system not only configured to analyze and extract data associated with virtual environments and the virtual avatars within them, but also utilize artificial intelligence techniques to optimize the virtual avatars in order to enhance the augmented and/or virtual reality user experience. In addition, the present embodiments further have the capacity to ascertain key performance indicators, cultural/social/industry standards, user patterns, etc. in order to support rendering the optimized virtual avatars.

As described herein a “virtual avatar” is a cognitive anthropomorphic virtual object rendered via computer animation/graphics configured to interact with virtual environments for the purpose of not only providing a user the cognitive computing capabilities including to see, to hear, to communicate, to move, etc. within virtual environments, but also serving as virtual assistants/chatbots for the user to interact with within virtual environments that support embedded cognitive computing capabilities including but not limited to natural language dialogue, user recognition, artificial intelligence techniques, and the like. In a preferred environment, virtual avatars are depicted within virtual, augmented, mixed, and/or extended reality-based environments, in which virtual reality (“VR”) refers to a computing environment configured to support computer-generated objects and computer mediated reality incorporating visual, auditory, and other forms of sensory feedback. Augmented reality (“AR”) is technology that enables enhancement of user perception of a real-world environment through superimposition of a digital overlay in a display interface providing a view of such environment. For instance, augmented reality can provide respective visualizations of various layers of information relevant to displayed real-world scenes.

As described herein “optimizing an avatar” refers to continuously learning and applying applicable data configured to fill cultural gaps, knowledge gaps, social gaps, and the like associated with one or more of an avatar associated with a user and/or a virtual assistant/chatbot. Furthermore, a “trust index” refers to a metric for assessing the validity and reliability of data in order to prevent malicious tampering of the optimization process, and a “knowledge index” is a multi-dimensional data structure constructed on top of applicable data repositories and populated with structured data collected from the various sources of the repositories. The knowledge index may facilitate lookup of an entity and examination of corresponding attributes regarding cultural data, knowledge data, social data, and the like along with applicable gaps.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

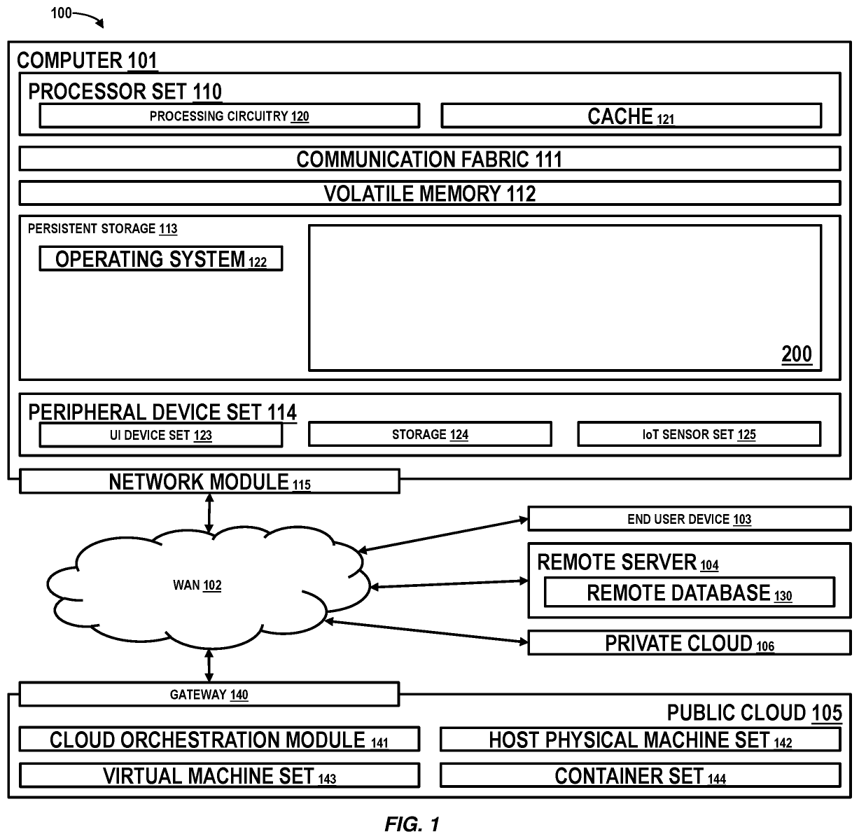

The following described exemplary embodiments provide a system, method, and computer program product for optimizing a virtual avatar. Referring now to FIG. 1, a computing environment 100 contains an example of an environment for the execution of at least some of the computer code involved in performing the inventive methods, such as system 200. In addition to system 200, computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

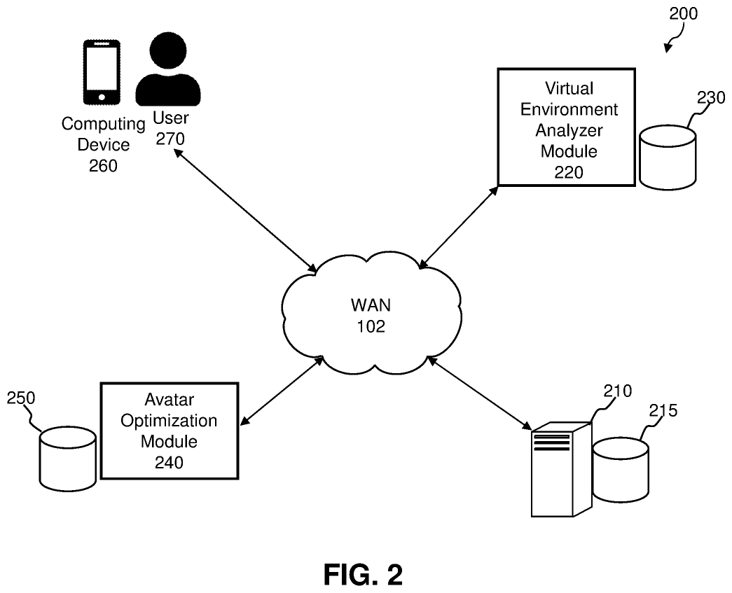

Referring now to FIG. 2, a functional block diagram of a networked computer environment illustrating a computing environment for an augmented reality experience merging environment system 200 (hereinafter “system”) comprising a server 210 communicatively coupled to a database 215, an virtual environment analyzer module 220 communicatively coupled to a virtual environment analyzer module database 230, an avatar optimization module 240 communicatively coupled to an avatar optimization module database 250, and a computing device 260 associated with a user 270, each of which are communicatively coupled over WAN 102 (hereinafter “network”) and data from the components of system 200 transmitted across the network is stored in database 215.

In some embodiments, server 210 is configured to operate a centralized platform serving as a cloud-based virtual environment analyzer and avatar rendering platform. Server 210 is configured to provide a mechanism of user 270 to not only view metrics, analytics, key performance indicators, etc. associated with virtual environments such as operating metaverses detected by virtual environment analyzer module 220, but also provide one or more user interfaces and application programming interfaces (APIs) to computing device 260 allowing user 270 to customize the generation and modification of their virtual avatars. It should be noted that system 200 is configured to support navigating nuances of workflows within virtual environments whether culturally, socially, educationally, etc. User activity, historical behavior, user feedback, etc. of user 270 allow for system 200 to gather insights pertaining to user 270 allowing avatar optimization module 240 to optimize virtual avatars by updating the virtual avatars to account for cultural/micro-cultural awareness, social awareness, skills specific to the applicable virtual environment (e.g., customer service engagement levels, aptitude of learning materials, requirements to achieve success, etc.), mannerisms and characteristics of user 270, and any other applicable type of avatar optimization assets. Additionally, the mechanism provided by server 210 that allows for customization of virtual avatars by user 270 that facilitate modification of the full spectrum of avatar features associated with physical appearance, vocal characteristics, VR/AR functionality/capabilities, and the like.

Virtual environment analyzer module 220 is configured to detect virtual environments and ascertain data associated with virtual environments including, but not limited to, contextual data, geographic data associated with applicable users and data sources, avatar data, expertise data, share learning insights, user reactions to interaction patterns/virtual environment features, event data associated with events occurring within virtual environments, and the like. The aforementioned data that is ascertained by virtual environment analyzer module 220 is configured to be stored in virtual environment analyzer module database 230, in which virtual environment analyzer module database 230 is designed to function as a repository continuously updated with not only data ascertained by analyses performed by virtual environment analyzer module 220, but also other applicable data sources including but not limited to crowdsourcing platforms, internet based data sources ascertained by web crawlers (e.g., social media platforms), inputs of user 270 provided to the centralized platform, and the like. In some embodiments, contextual factors, parameters, and/or user preferences such as, for example, current weather conditions, a geographical location, physical features and styling, likes and dislikes, user's purchase and/or interest, and the like may be accounted for in virtual environment analyzer module database 230. It should be noted that contextual data may be associated with the applicable setting, industry, geo-location, conversation/dialogue of participants, or any other applicable ascertainable contextual-based factors. Virtual environment analyzer module 220 may further utilize one or more techniques to analyze virtual environments including, but not limited to, natural language processing (NLP), image analysis, topic identification, virtual object recognition, setting/environment classification, and any other applicable artificial intelligence and/or cognitive-based techniques known to those of ordinary skill in the art.

Avatar optimization module 240 is configured to not only optimize virtual avatars, but also to maintain avatar optimization module database 250. In addition to an avatar serving as an anthropomorphic representation of user 270 within a virtual environment, the avatar may also function as a manager of computational tasks of machine learning problems and virtual element of a given virtual environment based on one or more of a continuously updated user profile associated with user 270, assessments of virtual avatars within a given virtual environment, key performance indicators derived from virtual environment analyzer module 220, etc. Key performance indicators may be ascertained from various manners including, but not limited to, analyzing the virtual avatar and the avatar templates, comparing to data acquired by server 210, and the like. In some embodiments, avatar optimization module database 250 functions as a continuously updated repository receiving various types of data associated with user 270 including, but not limited to, user activity data, cultural-based data, sensor-based data (e.g., data derived from computing device 260), user engagement data, user inputs (e.g., linguistic inputs, user inputs to the centralized platform, etc.), user feedback data, user social media-based data, crowd-sourced data, data derived from internet-based data sources accessed via web crawlers (e.g., weather, news, etc.), and the like. It should be noted that interactions between user 270 and various elements of virtual environments (e.g., other users, chatbots, virtual objects, etc.) may be the source of data extracted for storage within avatar optimization module database 250. For example, intelligent workflows implemented across various geographic locations that account for geographic specific cultural learnings may be accounted for by avatar optimization module 240 resulting in virtual avatars being modified and/or updated based on at least data within avatar optimization module database 250. In some embodiments, avatar optimization module 240 determines standards, metrics, key performance indicators, and the like associated with one or more of avatars associated with user 270 and/or avatar templates maintained by virtual environment analyzer module 220, in which avatar optimization module 240 generates confidence scores associated with the virtual avatar based on weighing the key performance indicators and stores the confidence scores in avatar optimization module database 250. In addition, optimization module database 250 further comprises one or more of a skill level, a cultural metric, a metaverse context, and a plurality of avatar templates. The aforementioned scores, indicators, and data assist avatar optimization module 240 with redefining the avatar, in which data associated with the redefining may be extracted as redefined avatar data and transmitted based on geographic location and skill level of users within the virtual environment. Thus, allowing avatars to reflect the up-to-date cultural, social, etc. skills associated with the respective geographic location of their applicable users.

Computing device 260 may take the form of a desktop computer, laptop computer, tablet computer, smart phone, smart watch or other wearable computer, mainframe computer, computer-mediated reality (CMR) device/VR device, quantum computer or any other form of computer or mobile device now known or to be developed in the future that is capable of running a program, accessing a network or querying a database. It should be noted that in the instance in which computing device 260 is a CMR device (e.g., VR headset, AR goggles, smart glasses, etc.) or other applicable wearable device, computing device 260 is configured to collect sensor data via one or more associated sensor systems including, but are not limited to, cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a radar sensor, a LiDAR sensor, a temperature sensor, a humidity sensor, a motion sensor, internet-of-things (“IoT”) sensors, or any other applicable type of sensors known to those of ordinary skill in the art.

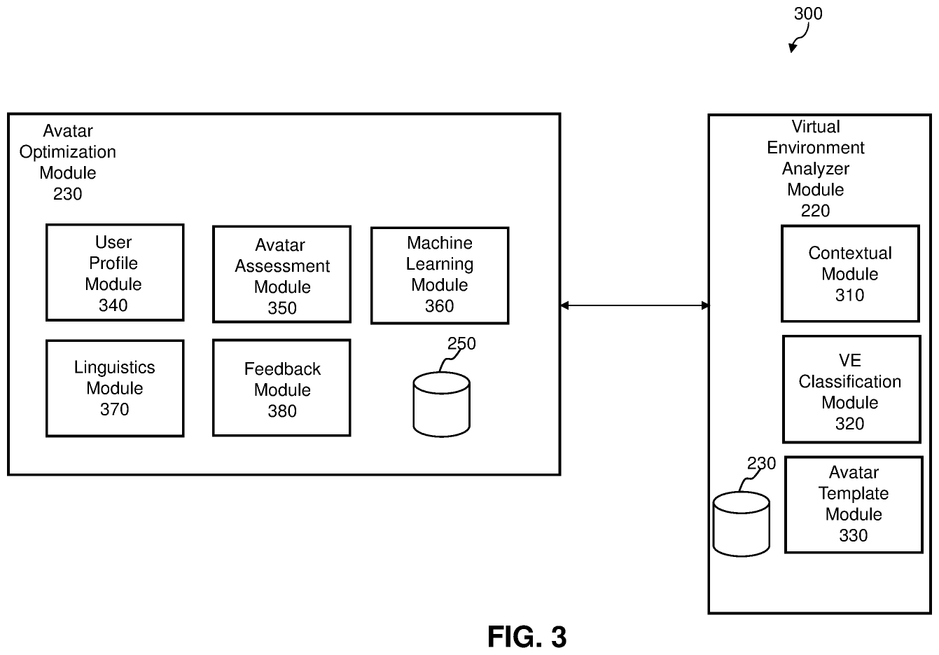

Referring now to FIG. 3, an example architecture 300 of virtual environment analyzer module 220 and avatar optimization module 240 is depicted, according to an exemplary embodiment. In some embodiment, virtual environment analyzer module 220 comprises a contextual module 310, a virtual environment (VE) classification module 320, and an avatar template module 330. Avatar optimization module 240 comprises a user profile module 340, an avatar assessment module 350, a machine learning module 360, a linguistics module 370, and a feedback module 380. Outputs of one or more machine learning models operated by machine learning module 360 are configured to be stored in one or more of database 215, virtual environment analyzer module database 230, and avatar optimization module database 250, in which the machine learning models may train datasets based on data derived from one or more of server 210, virtual environment analyzer module 220, avatar optimization module 240, and any other applicable data sources (e.g., internet-based data sources). In some embodiments, database 215, virtual environment analyzer module database 230, and avatar optimization module database 250 function as corpuses for crowdsourced data and other applicable data types derived from a plurality of virtual environments (e.g., metaverses, and the like) iteratively analyzed over one or more periods of time. Contextual module 310 is designed to determine the context of a virtual environment, in which the context may be established by one or more of the virtual environment elements (e.g., setting, theme, virtual objects, etc.), dialogue among users and participating virtual elements (e.g., chatbots, instructions, etc.) within the virtual environment, transactions within the virtual environment, workflows occurring within the virtual environment, and the like. For example, contextual module 310 may ascertain the context of a virtual environment by analyzing applicable workflows in order to determine user 270 is engaging in customer service support, opening a bank account, making a retail purchase, making repairs, and other common scenarios spanning work and training environments. Concurrently, virtual environment analyzer module 220 is continuously learning various aspects of the workflows and associated contexts via processing various data associated with the virtual environment and user 270 (e.g., sensor data, user behavior activity, user responses, etc.) in order to ascertain avatar data for storage in virtual environment analyzer module database 230. One of the underlying purposes in ascertaining the avatar data is for avatars to mimic human character, responses, and conversation and interaction which is integrated into the avatar generation stage. In some embodiments, the ascertained contextual data allows learned skills, feedback, etc. to continuously be added to virtual environment analyzer module database 230 based on specific industry-based scenarios pertaining to, but not limited to, finance/banking, medicine, education, arts, medicine, travel, technology, and any other applicable field. For example, upon virtual environment analyzer module 220 analyzing a particular virtual environment and detecting user 270 interacting with a chat-bot avatar and detecting the terms “new account” and “checking”, contextual module 310 determines that user 270 is attempting to open a checking bank account and the virtual environment setting is a financial institution. Simultaneously, avatar assessment module 350 is analyzing the virtual avatar associated with user 270 and any other applicable avatar within the virtual environment in order to ascertain vocal features, physical characteristics, mannerisms, etc. of user 270 for the purpose of optimizing the avatar while virtual environment analyzer module database 230 is being updated with the standards/regulations associated with the financial institution, financial institution practices (e.g., customer engagement dialogue, routine practices, required information, etc.) derived from one or more of server 210, collected sensor data, applicable third party sources, etc. It should be noted that the contextual data may be utilized by avatar optimization module 240 to tailor avatars for specific industries, levels of cultural awareness, etc. in a manner in which trust is built to ensure the active learning by avatars are sustainable and within proper ethics in accordance with the applicable industries.

Virtual environment classification module 320 is designed to classify virtual environments along with virtual elements within virtual environments. As described herein, virtual elements may include, but are not limited to, virtual objects, virtual actions, image, video, sound, resource requirements, or any other applicable virtual/augmented/mixed/extended reality-based elements designed to support interactions with users known to those of ordinary skill in the art. VE classification module 320 is further configured to perform classification and categorization of the aforementioned along with one or more extracted features associated with virtual environments such as intent, entities, emotions, etc. in a manner that supports segmenting, tagging of metadata, and classification techniques such as, but not limited to, probabilistic classification, Bayes classification, binary classification, linear classification, hierarchical classification, and the like. For example, VE classification module 320 may utilize the aforementioned techniques to determine one or more necessary factors to support contextual module 310 ascertaining the contextual information. In some embodiments, VE classification module 320 may classify objects within live video feeds presented to computing device 260, in which the objects may be highlighted and/or annotated within the virtual environment, and determine points of interest or key focal points for the purpose of distinguishing physical structures, virtual objects, avatar classifications, etc. within the virtual environment. VE classification module 320 may further support historical mapping of placement and positioning of virtual elements within the virtual environment based on historical mappings of virtual environments stored within virtual environment analyzer module database 230.

Avatar template module 330 is configured to maintain a plurality of avatar templates designed to function as baseline elements for the generation and optimization of avatars. In some embodiments, the ascertained contextual information may be matched to one or more of the avatar templates resulting in guidelines to avatar optimization module 240 determining which ways an avatar needs to be optimized. The avatars are continuously being updated as applicable data pertaining to skills, industry standards, cultural awareness, data privacy and security, and the like are contributed to VE analyzer module database 230. In some embodiments, avatar templates are generated based on the established contextual data, in which the virtual avatars presented within a virtual environment are rendered based on the classification of the environment. For example, if the contextual data indicates that the virtual environment is associated with a financial institution (i.e., a bank), then user 270 may be presented with virtual avatars derived from the applicable avatar template bearing the appearance of bank tellers knowledgeable about various aspects of banking such as opening accounts, accounting, etc. One purpose of avatar template module 330 continuously updating the avatars in accordance with cultural-based, industry-based, and other applicable standards is to ensure that avatars generated based on the avatar templates conform to the necessary standard in order to optimize the experience of user 270. In some embodiments, the avatar templates are used to train virtual assistants allowing them to build and curate knowledge in addition to the avatar templates being utilized by machine learning module 360 as a source for datasets for operating large language models for determining what content should be learned by the virtual assistants. For example, the models may utilize the avatar templates as reference points as to not only where generated avatars should be knowledge-wise, but also the evolution of knowledge of the avatars and/or virtual assistants.

User profile module 340 is configured to generate user profiles associated with user 270 and other applicable users in the virtual environments. It should be noted that the user profiles are utilized as a source for customization of the avatars based on various data comprised within the user profiles including, but not limited to, user preferences, biological data (e.g., physical features, cultural-based data, etc.) user behavior data, user interaction data, user internet browsing-based data, social media-based data, learning profile data, and any other applicable user data known to those of ordinary skill in the art. In some embodiments, the user profiles account for regulatory updates associated with the applicable geographic location of user 270, which include updates to compliance requirements from general data protection regulation (GDPR) pertaining to incident management, organization controls, IT risk, and the like. In addition to GDPR compliance, updates may also be in compliance with a security standard (e.g., Center For Internet Security (CIS) 2.0), Health Insurance Portability and Accountability Act (HIPPA) compliance, uptime, costs, data policies (e.g., data location), reliability & performance (e.g., transaction per second (TPS) and autoscaling), cloud resources (e.g., central processing unit (CPU), memory (MEM), disk, and network bandwidth), etc.

Avatar assessment module 350 is designed to analyze and/or assess avatars within a given virtual environment in order to ascertain avatar data configured to be stored in avatar optimization module database 250. Avatar assessment module 350 is further configured to perform scoring on avatars based on the assessments in which the assessments take into consideration various factors such as but not limited to the aforementioned compliances, contextual information, user preferences, the aforementioned cultural/social standards, previous virtual environment interactions of user 270, and the like. One purpose of the scoring is to reflect the level of ethics and knowledge associated with an avatar overall and in some instances specific to a particular virtual environment. In addition, the scoring may be utilized to ascertain an ethics or knowledge gap associated with the avatar being assessed in which a determination that the avatar lacks exposure to a requirement (i.e., knowledge or skill requirement?) of a particular virtual environment may cause automated fulfillment by avatar assessment module 350 to satisfy the void. In some embodiments, avatar assessment module 350 implements a trust calculation which assigns a trust index to the avatars and a knowledge calculation which assigns a knowledge index to the avatars, in which the trust index and knowledge index are designed to be tamper-proof to prevent modification by malicious parties. The trust index and knowledge index may be factors in calculating the generated scores assigned to the avatars.

Machine learning module 360 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure. For example, machine learning module 370 is designed to maintain one or more machine learning models dealing with training datasets including data derived from the contextual information in order to generate predictions pertaining to avatars and other applicable virtual elements to be integrated into a virtual environment. In some embodiments, machine learning module 360 performs federated learning, which is a process for using machine learning algorithms to train models without necessitating the training data to be stored in a central location, such as database 215. For example, machine learning module 360 may employ a federated learning process by training respective machine learning models based on confidential data sets. Machine learning module 360 may further share one or more derivatives of the trained models, such as model weights or gradients with respect to the data points, for aggregation purposes. In some embodiments, the one or more machine learning models are designed to train datasets comprising one or more of the contextual data, cultural-based data, sensor data, linguistic inputs associated with the virtual environment, and the like.

Linguistics module 370 is designed to perform various tasks on linguistic inputs such as but not limited to parsing, tokenization, analyzing (e.g., semantic-based, context-based, etc.), or any other applicable or any other task/feature of linguistics, computer science, and artificial intelligence for processing natural language data. Linguistics module 370 is further configured to detect and analyze conversational dialogue occurring within a virtual environment among user 270, virtual avatars, and any other applicable virtual elements. In some embodiments, linguistics module 370 in combination with machine learning module 360 applies conversational artificial intelligence in order to perform tasks such as vocalizing behaviors, inflection, and communication patterns associated with user 270. Linguistics module 370 is further designed to receive linguistic inputs, such as a detected conversational utterance of user 270, and utilize natural language processing (NLP) techniques, term frequency-inverse document frequency (tf-idf) techniques, and corpus linguistic analysis techniques (e.g., syntactic analysis, etc.) to identify keywords, parts of speech, and syntactic relations within the linguistic inputs, said corpus linguistic analysis techniques including, but not limited to, part-of-speech tagging, statistical evaluations, optimization of rule-bases, and knowledge discovery methods, to parse, identify, and analyze linguistic inputs. Also, linguistics module 370 may perform featuring scaling techniques (e.g., rescaling, mean normalization, etc.) and word embedding techniques to vectorize and normalize feature sets.

Feedback module 380 is designed to operate one or more feedback loops directed towards VR/AR activities of user 270, and one or more optimizations applied to the virtual avatars. In some embodiments, feedback module 380 may initiate one or more question and answer (“Q&A”) sessions with user 270 regarding various components of the virtual environments and/or modifications applied to avatars based on key performance indicators, scoring, acquired skillsets, and other applicable components associated with the maintenance of system 200. Feedback module 380 is able to analyze outputs of the one or more machine learning models managed by machine learning module 360 in order to determine if the outputs in fact optimize the avatars and/or the AR/VR experience for user 270 overall. In some embodiments, the responses of user 270 to the Q&A sessions triggers one or more events that may create multiple options or dimensions of options to benefit the AR/VR experience for user 270. For example, virtual environment classification module 320 may establish that user 270 is engaged in a software troubleshooting exercise in which the combination of sensor data associated with user 270 (e.g., blood pressure reading, facial expressions, etc.) and linguistic inputs derived from the Q&A session indicate it is an unpleasant experience for user 270. Feedback module 380 may utilize the aforementioned data to assist with determining key performance indicators, characteristics of chatbots, likes/dislikes of user 270 regarding virtual experiences, skill gaps of user 270 and/or applicable avatars, and the like. In some embodiments, feedback module 380 may repeat the receiving and analyzing of feedback on data derived from one or more of server 210, virtual environment analyzer module 220, avatar optimization module 240, and computing device 260 in order to repeat evaluations of feedback to determine when user 270 or an applicable avatar reaches a proficiency threshold for the virtual environment in light of the contextual data.

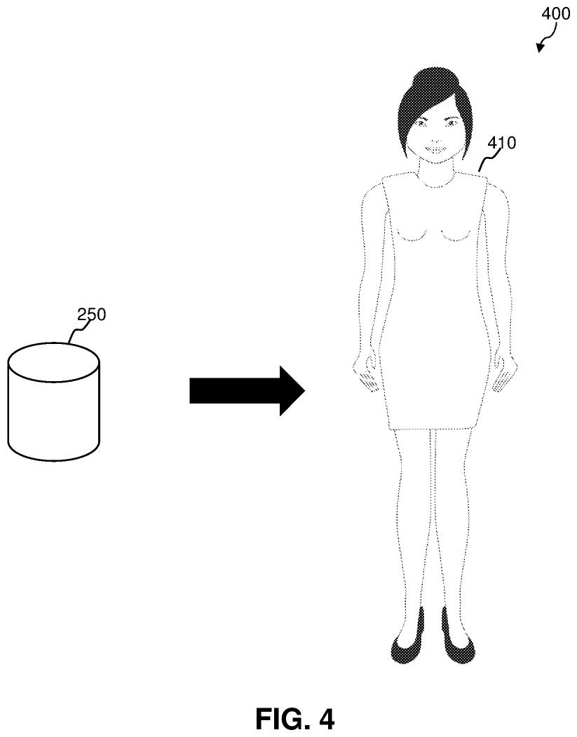

Referring now to FIG. 4, an avatar template 400 is presented, according to an exemplary embodiment. In some embodiments, template 400 may be utilized to generate a virtual avatar 410 configured to represent user 270 within a virtual environment. Avatar template 400 may be updated and maintained based on various data, such as avatar data, stored in avatar optimization module database 250, which may be used to generate and/or modify virtual avatar 410. For example, virtual interactions, purchase transactions, conversational dialogues with other users/avatars, intelligent workflows, cultural/social gaps, and the like associated with user 270 may be ascertained and stored in avatar optimization module database 250 allowing virtual avatar 410 to be modified based on the appropriate data resulting in the optimization of virtual avatar 410 within the applicable virtual environment. For example, social media data associated with user 270 derived from user profile module 340 and server 210 may be selected based on the contextual data ascertained by contextual module 310 resulting in not only virtual avatar 410 being optimized in light of the contextual data pertaining to the current virtual environment, but also social/cultural skill gaps associated with user 270 being filled via the modification of virtual avatar 410.

In some embodiments, transferring of data from avatar optimization module database 250 to avatar 410 may be based on the proficiency threshold being exceeded, in which the proficiency threshold may take into consideration factors such as, but not limited to, calculated scores, trust index, knowledge index, weights derived thereof, and the like. For example, avatar 410 indicating user 270 is not knowledgeable regarding a matter relevant to the current virtual environment may result in the proficiency threshold being exceeded prompting avatar optimization module database 250 to be accessed in order to provide avatar 410 the necessary information in order to address the knowledge and/or skill gap.

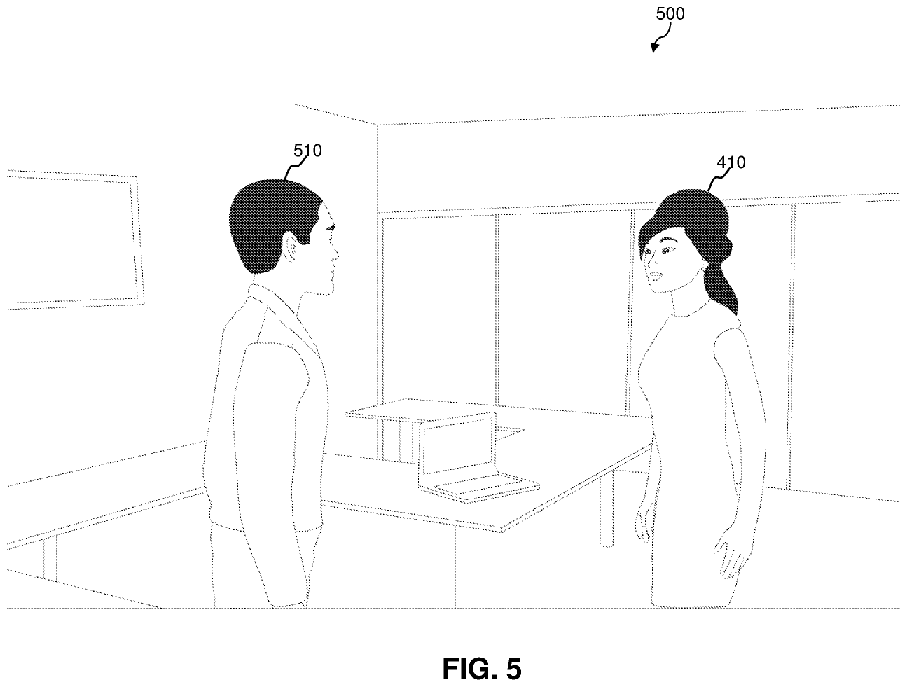

Referring now to FIG. 5, a virtual environment 500 is depicted, according to an exemplary embodiment. As presented, virtual environment 500 comprises avatar 410 conversing with a virtual chatbot avatar 510 selected based on an analysis performed on virtual environment 500 by virtual environment analyzer module 220. In this instance, avatar 410 is serving as a virtual proxy of user 270 who is conversing with chatbot avatar 510 regarding troubleshooting her computer. Contextual module 310 has established that virtual environment 500 is a help desk, and that user 270 is in need of assistance. In some embodiments, the Q&A session may be administered via chatbot avatar 510, in which response of user 270 to administered questions results in one or more trigger events associated with navigating virtual environment 500. For example, if chatbot avatar 510 asks “Have you encountered this issue before?” it may be ascertained by avatar assessment module 350 that organizational, geographical, cultural, social, etc.-based skill gaps exist, resulting in a trigger event of server 210 instructing applicable web crawlers to gather relevant data regarding the field of the detected skill gap. Therefore, avatar optimization module database 250 is updated with the applicable data to address the detected skill gap and avatar 410 may be optimized accordingly. In another example, virtual environment 500 may be a virtual tax office in which chatbot avatar 510 may provide avatar 410 with advice for a specific investment based on analysis of the user profile associated with user 270 along with the outputs of the one or more machine learning models. In addition, feedback module 380 is continuously analyzing outputs of virtual environment analyzer module 220 and avatar optimization module 240 in order to mimic character traits, responses, conversations/interactions, and the like in light of continuous updates to repositories, virtual environment analyzer module database 230 and avatar optimization module database 250. This allows avatar 410 to learn skills, playback, and teach user 270, while simultaneously adding learning and feedback to the aforementioned databases based on specific industry-based scenarios. For example, social and cultural skill gaps associated with user 270 may be ascertained by avatar optimization module 240 analyzing the dialogue between avatar 410 and chatbot avatar 510 in which the skill gap is indicated within the user profile triggering server 210 and feedback module 380 to communicate in order to fulfill the skill gap.

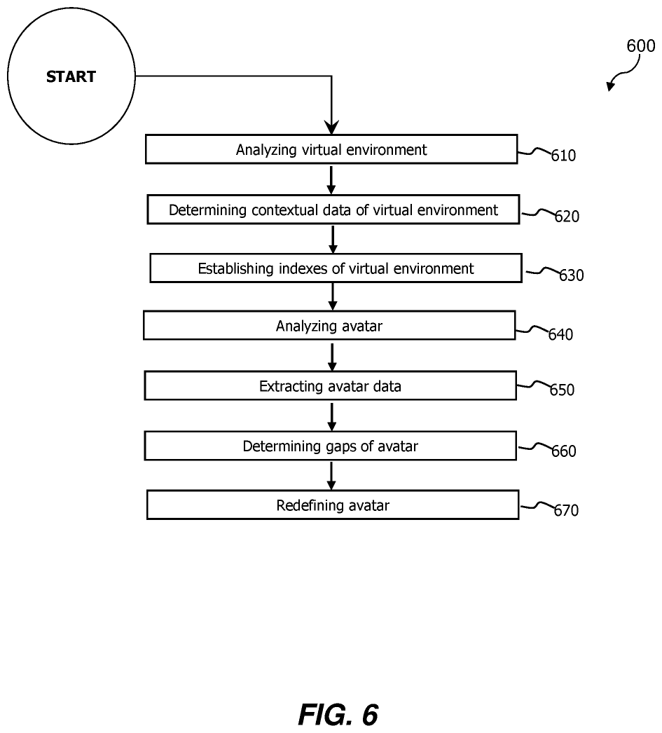

With the foregoing overview of the example architecture, it may be helpful now to consider a high-level discussion of an example process. FIG. 6 depicts a flowchart illustrating a computer-implemented process 600 for optimizing a virtual avatar, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, virtual environment analyzer module 220 analyzes the applicable virtual environment. It should be noted that virtual environments, such as but not limited to metaverses, may have image/video analysis, parsing, tokenizing, 3D point cloud segmentation, or any other applicable VR/AR-based analysis mechanism known to those of ordinary skill in the art. Detected avatars, virtual objects/features, virtual environment layouts, and the like may support the analysis of the virtual environment performed by virtual environment analyzer module 220. In some embodiments, data associated with user 270 may be ascertained by computing device 260 via user interactions with the virtual environment. For example, analysis of targets associated with user gaze detection, frequently interacted with virtual objects, visual preferences, and the like are within the scope of this disclosure. Data derived from feedback module 380 may also be applied during the virtual environment analysis phase in instances where the trust index and knowledge index needs to be fine-tuned. For example, features necessary to ascertain trust index and knowledge index during the avatar analysis process may not initially result in the most useful information for determining industry-specific metrics and standard, in which the feedback loop managed by feedback module 380 may assist virtual environment analyzer module 220 in iteratively targeting more useful information. It should be noted that one of primary purposes of analyzing the virtual environment is to ascertain one or more skill gaps associated with the virtual avatar.

At step 620 of process 600, contextual module 310 determines the contextual data of the virtual environment based on the analysis. Contextual data may be ascertained from the dialogue, layouts, and/or virtual elements integrated within the virtual environment such as, but not limited to, avatars, widgets, and any other applicable computer-generated objects and computer mediated reality incorporating visual, auditory, and other forms of sensory feedback. In a preferred embodiment, the contextual data establishes at the least the industry-specific setting that the virtual environment is associated with, in which the industries may include but are not limited to financial/banking, entertainment, cooking, industrial, healthcare, and the like. In some embodiments, once the contextual information of a virtual environment is established, feedback module 380 may execute Q&A sessions with user 270 via the avatar in order to deduce logic by execution of intelligent workflows associated with a task. The logic may be subject to a decision tree and/or any other applicable model designed to address consequences, chance event outcomes, resource costs, utility, and the like. For example, upon the contextual information ascertained by contextual module 310 establishing that the current virtual environment is a healthcare setting, feedback module 380 executes a Q&A session with user 270 regarding patient history, medical compliance, and the like allowing social, cultural, and skill gaps associated with user 270 to be ascertained and rectified.

At step 630 of process 600, machine learning module 360 establishes indexes of the virtual environment. The indexes may be ascertained regarding both the virtual environment and its virtual elements therein, in which contextual information of a virtual environment assists with determining a trust and knowledge standard regarding specific industries; however, continuous monitoring and learning of avatars is the foundation for establishing the trust index and knowledge index in light of cultural and ethics assessments being performed by avatar assessment module 350. In some embodiments, indexes may be established by regulating agencies regarding particular domains in order to not only assure accurate and universal knowledge is being shared among the avatars, but also to allow calculated scores to serve as the threshold/barrier into specific virtual environments for avatars (e.g., preventing malicious code, bots, and the like).

At step 640 of process 600, avatar assessment module 350 performs assessment of the avatars within the virtual environment. By performing continuous monitoring and learning techniques on the avatar, avatar assessment module 350 ascertains vocal features, physical characteristics, mannerisms, etc. of user 270. In addition, linguistics module 370 and feedback module 380 assist avatar assessment module 350 in performing the assessment by providing features such as linguistics module 370 establishing conversational boundaries within virtual environment dialogues that allow feedback module 380 to guide and assist user 270 through virtual environments via Q&A sessions, dynamic VR/AR-based guidance tools, logic/decision support, and the like. Machine learning module 360 may also assist by utilizing the one or more machine learning models to generate outputs pertaining to conversational pattern predictions based on training data sets including the contextual information. For example, user 270 may be receiving technical support in which outputs of the one or more machine learning models may be utilized for feedback module 380 to determine the decision/logic flow of the applicable intelligent workflow associated with the virtual environment and/or current task.

At step 650 of process 600, avatar assessment module 350 extracts avatar data from the avatars being analyzed. Avatar data may account for various types of data ascertainable from the avatars within virtual environments including, but not limited to, sensing data, channel state information (CSI), phase information, electromyography associated data, and the like. In some embodiments, the sensing data and the sensor data collected by computing device 260 may be correlated, aggregated, merged, etc. in order to ascertain character traits, responses, conversations/interactions, and the like associated with user 270. For example, facial reactions of user 270 to specific statements and/or topic may be learned by the avatar based on the assessments performed by avatar assessment module 350, along with detected facial reactions of other avatars interacting with user 270 (e.g., controversial statement, indecipherable language, etc.). In some embodiments, avatar assessment module 350 may perform the assessments in accordance with service needs of user 270, preferences, situations, and adjustments rendered in accordance with computing resources of service equipment. The assessments are configured to be utilized for avatar reconstruction performed by virtual environment analyzer module 220, in which the reconstruction is the process of redefining the avatar in light of the various analyses performed by virtual environment analyzer module 220 and avatar optimization module 240. For example, the redefining of the avatar is rendered based on the analyses of the virtual environment performed by virtual environment analyzer module 220 and the assessment of the avatar data performed by avatar optimization module 240.

At step 660 of process 600, avatar assessment module 350 determines one or more gaps associated with the assessed avatar. It should be noted that the gaps may apply to one or more cultural, social, and/or industry-specific skill gaps. In some embodiments, the scoring performed by avatar assessment module 350 is utilized in order to ascertain the gaps, in which the scoring is based on various factors such as industry-specific compliances, contextual information, user preferences, cultural/social standards, and any other applicable ascertainable metric designed to ensure that a person or representative is in objectively good moral, social, or professional standing. For example, the scoring may be utilized to ascertain an ethics or knowledge gap associated with the avatar in which a determination that the avatar lacks exposure to requirements of a virtual environment may cause automated fulfillment by avatar assessment module 350 to satisfy the void during the avatar redefining phase.

At step 670 of process 600, avatar optimization module 240 redefines the avatar. Redefining the avatar may be based on analyses performed by virtual environment analyzer module 220 and assessments rendered by avatar optimization module 240. In some embodiments, redefining may further be based on data derived from server 210 in which various sources of data may be matched and aligned with the avatar templates managed by avatar template module 330 in order to ensure that avatars generated from the avatar templates are in compliance with the trust index, knowledge index, etc. associated with the redefining process pertaining to the avatar representing user 270.

Based on the foregoing, a method, system, and computer program product have been disclosed. However, numerous modifications and substitutions can be made without deviating from the scope of the present invention. Therefore, the present invention has been disclosed by way of example and not limitation.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for optimizing a virtual avatar, the method comprising:
analyzing, by a computing device, a virtual environment in order to ascertain one or more skill gaps associated with the virtual avatar;
receiving, by the computing device, a plurality of avatar data; and
redefining, by the computing device, the virtual avatar by filling the one or more skill gaps based on the analysis and the plurality of avatar data.

2. The computer-implemented method of claim 1, further comprising:
based on the redefining, extracting, by the computing device, a plurality of redefined avatar data and transmitting the plurality of redefined avatar data based on one or more of a geographic location and a skill level associated with the virtual environment.

3. The computer-implemented method of claim 1, wherein the plurality of avatar data is derived from a corpus comprising one or more of a skill level, a cultural metric, a metaverse context, and a plurality of avatar templates.

4. The computer-implemented method of claim 1, wherein receiving the plurality of avatar data comprises:
utilizing, by the computing device, one or more machine learning models designed to process one or more of a plurality contextual data, a plurality of cultural-based data, a plurality of sensor data, and a plurality of linguistic inputs associated with the virtual environment.

5. The computer-implemented method of claim 1, wherein analyzing the virtual environment comprises:
classifying, by the computing device, a type of the virtual environment based on a plurality of linguistic inputs associated with a plurality of users operating within the virtual environment.

6. The computer-implemented method of claim 3, wherein analyzing the virtual environment comprises:
determining, by the computing device, a plurality of key performance indicators associated with the virtual avatar based on one or more of a user associated with the virtual avatar and the plurality of avatar templates; and
generating, by the computing device, a confidence score associated with the virtual avatar based on weighing the plurality of key performance indicators.

7. The computer-implemented method of claim 3, wherein the corpus is generated based on a plurality of crowdsourced data derived from a plurality of metaverses configured to be iteratively analyzed over a period of time.

8. A computer program product for optimizing a virtual avatar, the computer program product comprising or more computer readable storage media and program instructions collectively stored on the one or more computer readable storage media, the stored program instructions comprising:
program instructions to analyze a virtual environment in order to ascertain one or more skill gaps associated with the virtual avatar;
program instructions to receive a plurality of avatar data; and
program instructions to redefine the virtual avatar by filling the one or more skill gaps based on the analysis and the plurality of avatar data.

9. The computer program product of claim 8, further comprising:
program instructions to extract a plurality of redefined avatar data and transmitting the plurality of redefined avatar data based on one or more of a geographic location and a skill level associated with the virtual environment in response to the redefining.

10. The computer program product of claim 8, wherein program instructions to receive the plurality of avatar data further comprise:
program instructions to utilize one or more machine learning models designed to process one or more of a plurality contextual data, a plurality of cultural-based data, a plurality of sensor data, and a plurality of linguistic inputs associated with the virtual environment.

11. The computer program product of claim 8, wherein program instructions to analyze the virtual environment comprise:
program instructions to classify a type of the virtual environment based on a plurality of linguistic inputs associated with a plurality of users operating within the virtual environment.

12. The computer program product of claim 8, wherein the plurality of avatar data is derived from a corpus comprising one or more of a skill level, a cultural metric, a metaverse context, and a plurality of avatar templates.

13. The computer program product of claim 12, wherein program instructions to analyze the virtual environment comprise:
program instructions to determine a plurality of key performance indicators associated with the virtual avatar based on one or more of a user associated with the virtual avatar and the plurality of avatar templates; and
program instructions to generate a confidence score associated with the virtual avatar based on weighing the plurality of key performance indicators.

14. A computer system for optimizing a virtual avatar, the computer system comprising:
one or more processors;
one or more computer-readable memories;
program instructions stored on at least one of the one or more computer-readable memories for execution by at least one of the one or more processors, the program instructions comprising:
program instructions to analyze a virtual environment in order to ascertain one or more skill gaps associated with the virtual avatar;
program instructions to receive a plurality of avatar data; and
program instructions to redefine the virtual avatar by filling the one or more skill gaps based on the analysis and the plurality of avatar data.

15. The computer system of claim 14, further comprising:
program instructions to extract a plurality of redefined avatar data and transmitting the plurality of redefined avatar data based on one or more of a geographic location and a skill level associated with the virtual environment in response to the redefining.

16. The computer system of claim 14, wherein program instructions to receive the plurality of avatar data further comprise:
program instructions to utilize one or more machine learning models designed to process one or more of a plurality contextual data, a plurality of cultural-based data, a plurality of sensor data, and a plurality of linguistic inputs associated with the virtual environment.

17. The computer system of claim 14, wherein the plurality of avatar data is derived from a corpus comprising one or more of a skill level, a cultural metric, a metaverse context, and a plurality of avatar templates.

18. The computer system of claim 17, wherein program instructions to analyze the virtual environment comprise:
program instructions to determine a plurality of key performance indicators associated with the virtual avatar based on one or more of a user associated with the virtual avatar and the plurality of avatar templates; and
program instructions to generate a confidence score associated with the virtual avatar based on weighing the plurality of key performance indicators.

19. The computer system of claim 17, wherein program instructions to analyze the virtual environment comprise:
program instructions to classify a type of the virtual environment based on a plurality of linguistic inputs associated with a plurality of users operating within the virtual environment.

20. The computer system of claim 17, wherein the corpus is generated based on a plurality of crowdsourced data derived from a plurality of metaverses configured to be iteratively analyzed over a period of time.
